(19) United States
(12) Patent Application Publication
(10) Pub. No.: US 2026/0116285 A1
(43) Pub. Date: Apr. 30, 2026

(54) METHOD FOR DISPLAYING THE CHARGING STATE OF AN ENERGY STORAGE DEVICE OF A VEHICLE, AND A VEHICLE

(71) Applicant: MERCEDES-BENZ GROUP AG, Stuttgart (DE)

(72) Inventor: Markus KUTSCHKE, Stuttgart (DE)

(21) Appl. No.: 18/840,230

(22) PCT Filed: Dec. 12, 2022
(86) PCT No.: PCT/EP2022/085413

§ 371 Date: Aug. 21, 2024

(30) Foreign Application Priority Data
Feb. 22, 2022 (DE) 10 2022 000 639.1

(51) Int. Cl. B60Q 1/50; B60L 58/12; B60Q 1/04

(52) U.S. Cl. CPC B60Q 1/543; B60L 58/12; B60Q 1/04; B60Q 2400/50

(57) ABSTRACT

The charging state of an energy storage device of a vehicle is displayed by a lighting device of the vehicle. The lighting device projects a charging state in the form of a graphic onto a surface in the surrounding area of the vehicle. The lighting device starts the projection of the charging state into the surrounding area when the vehicle detects, by an environment sensor system, an approach of a vehicle, a person, or an identification feature that is below a defined distance from the vehicle.

### BACKGROUND AND SUMMARY OF THE INVENTION

Exemplary embodiments of the invention relate to a method for displaying the charging state of an energy storage device of a vehicle and to a corresponding vehicle for carrying out the method.

If a battery electric vehicle is charged at a charging station, it is usually difficult to recognize from the outside how far the charging has progressed. A current charging state of the traction battery of the vehicle can, for example, be read off from the charging station, can be displayed in the vehicle on a display, or can be read via an application executed on a mobile end device, which is coupled directly or indirectly with the vehicle and/or the charging station via a cloud service. Furthermore, a lighting device can be integrated at different points on the charging interface, for example on the charging plug itself or in the matching charging socket of the vehicle, which can indicate, for example, whether a charging process is in progress or has ended by radiating colored lights, or whether the charging process was cancelled or cannot be carried out due to a fault.

Furthermore, a method for displaying the charging state of the energy storage device of the vehicle by means of a lighting device of the vehicle is known from DE 10 2011 115 161 A1 and DE 10 2012 007 224 A1. The documents describe the use, for example, of daytime running lights, indicators, taillights, additional brake lights, registration plate lighting or similar, to display a light signal representing the charging state. For example, the charging state of a traction battery of the vehicle can be visualized as a bar display via the plurality of LEDs of the additional brake light of the vehicle. Depending on the situation, the individual lighting devices can also radiate light of different colors.

The above-described methods for visualizing the charging state of the vehicle's energy storage device have the disadvantage that the charging state cannot be readily detected in passing by the vehicle, or that it is not readily clear to an uninvolved third party what the meaning of the light signal emitted by a lighting device of the vehicle is.

The output of information about the current charging state of the vehicle's energy storage device is moreover not only relevant during the charging process, but also, for example, when a vehicle user wants to use their vehicle again after a prolonged parking period, such as after a holiday.

Furthermore, DE 10 2013 226 188 A1 discloses a surround light having a status display. By means of the surround light, the status and additionally the charging state of a vehicle's drive battery can be projected into the area surrounding the vehicle. The surround light is integrated into a side mirror or a door handle. The surround light can be activated manually by a vehicle user, by the vehicle user unlocking the vehicle by means of a remote control key.

In addition, DE 10 2020 000 293 A1 discloses an apparatus for a vehicle and a method for projecting symbols onto a section of road. To project different symbols, the apparatus has a separate arrangement consisting of object mapping and light source for each symbol to be projected. By means of the apparatus, for example, warnings can be projected into the area surrounding the vehicle.

Furthermore, DE 10 2017 211 430 A1 discloses controlling a pixel headlight of a vehicle. Initially, a particularly bright light is cast onto a road by means of the pixel headlight(s) for a particularly short moment, so that a person cannot perceive it, in order to illuminate the road and simultaneously record an image with a vehicle camera. This image is analyzed in order to give an indication of the road features. A comparison is made with a database in order to specify whether the information represented by the indicative road features is actually correct. If this is not the case, the indicative road features are omitted from further illumination by the pixel headlight or is overlit with correct information.

Furthermore, a plug-in vehicle function display is taken as known from DE 10 2010 002 514 A1. The function display is fixed in a vehicle interior on a trim component and can be viewed from outside the vehicle. The function display can be used to show information relating to a charging process currently being carried out on the vehicle's electrical energy storage device. The function display is automatically activated when the charging process starts and/or when door locking is actuated and can automatically be deactivated after a specified time period has elapsed. In addition, the luminous intensity emitted by the function display can be adjusted depending on the ambient brightness measured by a light sensor.

Exemplary embodiments of the present invention are directed to a method for displaying the charging state of an energy storage device of a vehicle that is improved in relation to the prior art.

A generic method for displaying the charging state of an energy storage device of a vehicle, in which the charging state is displayed by means of a lighting device of the vehicle, and the charging state is projected in the form of a graphic onto a surface in the surrounding area of a vehicle by the lighting device, wherein the lighting device starts the projection of the charging state into the surrounding area when the vehicle detects, by means of an environment sensor system, an approach of a vehicle, a person, and/or an identification feature that is below a defined distance from the vehicle with, is developed according to the invention in that at least one front headlight of the vehicle is used as a lighting device; and the projection of the charging state into the surrounding area is ended after a deactivation event has occurred; wherein one of the following actions is used as a deactivation event:
closing an open vehicle door;
locking the vehicle doors;
entering a manual operator control action;
activating the vehicle ignition;
starting a drive engine of the vehicle; or
decoupling the vehicle from a charging station.

On the one hand, the method according to the invention enables the meaning of the information displayed by the lighting device to be grasped particularly quickly and intuitively. By displaying a graphic, people and even those who are not familiar with the vehicle are able to understand that the graphic displays the charging state of the energy storage device of the vehicle and the degree to which the energy storage device is charged with electrical energy. The graphic can be projected onto a vertical, diagonal, or horizontal surface. For example, the ground on which the vehicle is parked, a wall such as a house wall or a masonry, or another vehicle parked in front of the vehicle are suitable for this purpose.

In general, it would be possible for the graphic to be continuously projected into the surrounding area when the vehicle is stationary or parked. However, this is not absolutely necessary and on the one hand leads to a faster discharge of the energy storage device due to the power consumption for projection and can also be perceived as disturbing by people in the vicinity of the vehicle. It is therefore desirable that the charging state is only projected into the surrounding area when the display of the charging state is actually desired.

For this purpose, the vehicle monitors its immediate surroundings using an environment sensor system, which includes various environment sensors such as cameras, radar sensors, ultrasound sensors, and/or laser scanners. This allows dynamic surrounding objects such as vehicles and people to be detected and their distance to the vehicle to be recorded. If a vehicle and/or a person approaches the vehicle, the charging state is only projected when the corresponding vehicle and/or the corresponding person has approached the vehicle to at least the defined distance. With the aid of image recognition methods, people can also be distinguished from vehicles in camera images and the graphic can only be cast into the surrounding area if either a vehicle or a person is recognized. The defined distance can be chosen arbitrarily and can, for example, be configured by the infotainment system of the vehicle. The defined distance can however also be stored in a vehicle subsystem in a way that cannot be easily changed from within the vehicle, for example when the vehicle is manufactured. For example, the defined distance may be one meter, two meters, ten meters or also fractions or multiples thereof.

If, for example, the vehicle is being charged at a charging station, the vehicle projects its current charging state into the surrounding area when a person passes by the vehicle. As a result, the person is able to detect the current charging state and estimate how long the vehicle is likely to be parked at the charging station until the energy storage device is charged. This increases convenience for the person since they do not have to look into the vehicle or operate the charging station to detect the relevant information. For example, if the vehicle owner is in the vicinity of their vehicle, they could interpret the person's behavior as conspicuous. Such an unfavorable situation can be avoided with the aid of the method according to the invention.

The display of the charging state using the graphic also makes it possible for another person who wants to carry out a charging process at the charging station with their own electrified vehicle to detect the charging state as they pass by the charging station. As a result, the person passing by can estimate quickly and easily when the next free charging option will be available.

Situations may also arise in which the projection of the charging state is not automatically desired when it is detected that a vehicle and/or person is approaching the vehicle, but only when an authorized person is approaching the vehicle. Such an authorized person can be recognized by means of the identification feature. For example, the vehicle owner or vehicle user is in possession of the identification feature. This enables the charging state to then only be projected into the surrounding area when the vehicle owner approaches the vehicle. The fundamental idea is illustrated by the following example: The vehicle owner drives their vehicle to the airport and parks the vehicle there in the car park. They then go on holiday for two weeks. During this time, the projection of the charging state of the vehicle into the surrounding area is not desired since the energy storage device would unnecessarily be drained during this long period. Additionally, no one can gain an advantage from the charging state being displayed. However, if the vehicle owner returns from holiday and would like to drive the vehicle back home, it is important for the vehicle owner to detect the partially discharged charging state of the energy storage device due to the vehicle being parked for a long time, when approaching the vehicle. The vehicle recognizes by detecting the identification feature that the vehicle owner is approaching and so starts projecting the charging state. As a result, the vehicle owner can detect quickly and simply whether they should carry out another charging process with the vehicle at a charging station before a long drive back home.

The way in which the vehicle should project the charging state into the surrounding area can similarly be configured via an input device in the vehicle. A mobile end device, coupled with the vehicle or a cloud service or backend, and a corresponding application performed on the mobile end device, can be used for this purpose.

The use of the front headlights thus enables the display of many different graphics. The front headlights are particularly big in comparison and therefore make it particularly easy to integrate design changes into the projector. For example, different projection screens and/or different colored lighting means can be integrated into a front headlight so that a projection of graphics such as with a slide projector is possible. Due to their comparatively high luminosity, front headlights also enable graphics to be displayed particularly brightly and therefore clearly visible, even during the day. A front headlight can comprise one or more glow plugs, xenon lamps, LEDs, lasers and/or other light-emitting units. Furthermore, a front headlight can comprise various lenses, filters, diaphragms, mirrors, masks, diffusing lenses or other units that influence the light beam path generated by the front headlight. In particular, these can be moveable and controlled by an actuator.

The projection of the charging state into the surrounding area is ended after the deactivation event has occurred.

If a person going on holiday parks their vehicle in an airport car park, the charging state can once again be projected into the surrounding area when they leave the vehicle to inform the vehicle user of the current charging state of the vehicle when they leave. If the vehicle user closes the door after disembarking or locks the vehicle, the projection is ended.

By decoupling the vehicle from a charging station, the end of the charging process can be detected reliably and simply, whereby the projection of the charging state into the surrounding area is also adjusted.

The projection of the charging state can also be ended when a person in charge of the vehicle wants to drive off with the vehicle. This, for example, can be detected by activating the vehicle ignition or starting the drive engine of the vehicle. The projection of the charging state into the surrounding area can also be ended manually, for example by entering an operator control action via the vehicle's infotainment system, an application running on a mobile end device and/or by pressing a corresponding button on a remote-control key.

An advantageous development of the method provides that at least one symbol, pictogram, text, number, and/or special character is projected into the surrounding area by means of the graphic, at least two image sections of the graphic have a color, brightness, contrast, and/or transparency differing from each other, and/or at least one part of the graphic is animated. This enables a display of the charging state that can be grasped particularly intuitively. For example, a vehicle, a battery, a battery cell, a lightning bolt, a plug, or similar can be projected into the surrounding area as a symbol and/or pictogram. Text, numbers, and/or special characters can be used to display additional information such as a percentage charge level, for example ‘the traction battery is 80 per cent charged’. Further information can also be displayed, such as the remaining time required to charge the energy storage device to a preset value such as 100 per cent, a currently used charging current, charging voltage, and/or charging power or similar. This enables a person waiting for a charging option to estimate even more precisely when a corresponding charging station will become free.

By using different colors, brightnesses, contrasts, and/or transparency, the display variety of the graphic can be further increased. For example, a battery can be projected into the surrounding area in yellow when the vehicle's energy storage device is being charged and projected in green when the traction battery is fully charged. In the event of a fault, for example, the battery can be displayed in orange and in the event of a technical defect in red. The pictogram of the battery can also comprise a charging bar, for example, wherein already charged parts are displayed in a light color and parts still to be charged are displayed darker. For example, the charging bar can comprise five sections, with each of the bars representing 20 per cent charging state. This charging bar can also be animated, so that already charged parts are displayed permanently lit up and the part that is currently being charged flashes. Parts that are not yet charged are then dark, in another color, or not displayed at all.

During the charging process, the graphic can be supplemented by a plug, for example, so that the vehicle owner can quickly and easily see that the vehicle is plugged into the charging station and the charging process is taking place. When charging the energy storage device inductively, for example, a lightning bolt can be displayed, allowing the vehicle owner to quickly and easily recognize that the vehicle is charging. This is not always intuitively obvious, especially with inductive charging, as no plugs are inserted, which means that the coupling between the vehicle and the charging station is not immediately apparent.

Preferably, a headlight designed as a matrix headlight is used as a lighting device. Nowadays, a large number of vehicles already have matrix headlights. With the help of a matrix headlight, it is possible to project high-resolution information into the area surrounding a vehicle. This makes it possible to dispense with other design modifications, particularly to the front headlights. Additionally, animated graphics can be displayed particularly easily. The absence of moving parts also increases the service life of the matrix headlight.

According to a further advantageous embodiment of the method, an identification feature that is integrated into a vehicle key, a transponder, or a mobile end device is used. This makes it easy to assign the identification feature to the person driving the vehicle or the vehicle owner, for example. The vehicle key, transponder, and/or mobile end device can communicate via Bluetooth, ultra-wideband communication, NFC or similar, for example. The identification feature can be designed as code. The use of a transponder and/or a mobile end device also allows further people, near the person driving the vehicle, to bring about a projection of the charging state into the surrounding area when approaching the vehicle. Smartphones are already being used as digital vehicle keys. A code stored in a mobile end device in this process can then also be used as an identification feature.

In a vehicle with a lighting device, a computing unit, and an environment sensor system, the lighting device, the computing unit, and the environment sensor system are configured according to the invention to carry out a method described above. The vehicle can be any vehicle such as a car, lorry, van, bus, or similar. The environment sensor system can comprise different environment sensors, such as one or more cameras, laser scanners also referred to as LIDARs, radar sensors, ultrasound sensors, or the like. Sensor data generated by the respective environment sensors is analyzed by the vehicle's computing unit in order to detect the approach of a vehicle, a person and/or an identification feature to the vehicle. The environment sensors can also be used to determine the distance between the respective vehicle, person and/or identification feature and the vehicle. If the distance then falls below a defined level, the lighting device projects the charging state of the vehicle's energy storage device into the surrounding area. An exact distance determination, for example in meters, is therefore not necessarily required. If the charging state is projected after the identification feature has been recognized, for example, a radio range used to recognize the identification feature can be used to define the defined distance. If, for example, a radio key is within radio range of the vehicle, this is considered to be falling below the defined distance.

Preferably, a matrix headlight is used as a lighting device. The lighting device can however also comprise one or more matrix headlights. For example, both front headlights of the vehicle are used to project the graphic into the surrounding area.

The use of both front headlights designed as matrix headlights has the advantage that a particularly large projection field can be used to display the graphic. For example, an animation projected into the surrounding area using the left-hand vehicle headlight can be continued via the right-hand vehicle headlight. In addition, the front headlights usually have a comparatively high luminosity, which allows high-resolution graphics to be displayed with clear visibility. In addition, no other structural changes to the vehicle are necessary.

Further advantageous embodiments of the method according to the invention for the display of the charging state of the energy storage device of the vehicle, and of the vehicle, result from the exemplary embodiments which are described in more detail below with reference to the figures.

### BRIEF DESCRIPTION OF THE DRAWING FIGURES

The figures show:

FIG. 1 a schematic plan view of a vehicle according to the invention, which projects a charging state of its energy storage device as a graphic by means of a lighting device into the surrounding area;

FIG. 2 a schematic representation of an animated graphic; and

FIG. 3 a schematic representation of a graphic, supplemented by text.

### DETAILED DESCRIPTION

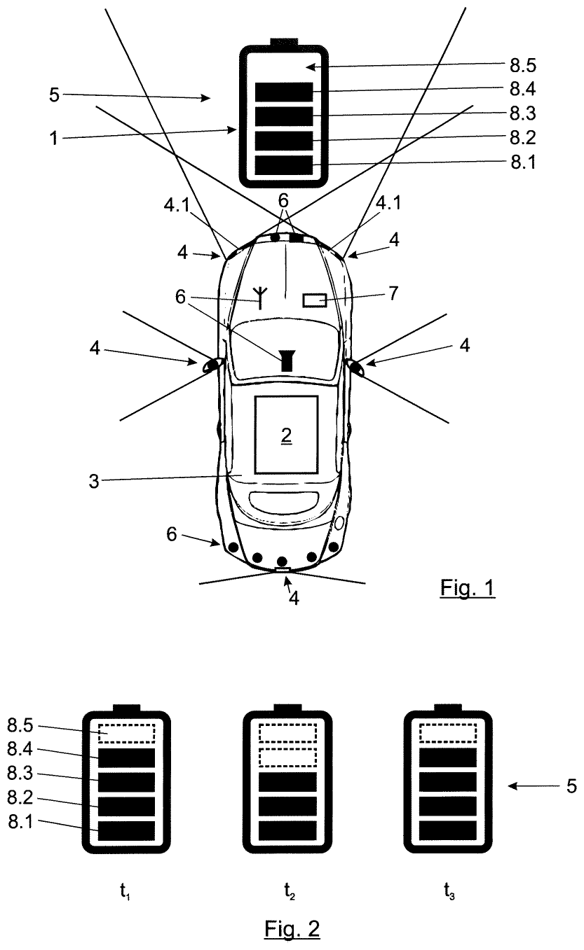

FIG. 1 shows a vehicle 3 according to the invention in a plan view. The vehicle 3 was parked and projects a charging state 1 of its energy storage device 2, for example of a traction battery, with a lighting device 4 into its close surrounding area. The vehicle 3 uses one of more headlights as a lighting device 4. The front headlights 4.1 are used. In particular, the headlights are matrix headlights, which enables the projection of high-resolution graphics 5 into the surrounding area.

The vehicle 3 begins the projection of the graphic 5 into the surrounding area when an approach of a vehicle, a person, and/or an identification feature that is below a defined distance from the vehicle 3 is detected by means of an environment sensor system 6. The environment sensor system 6 may comprise a camera, ultrasound sensor, radar sensor, laser scanner, and/or also an antenna. The detection of an identification feature transmitted by radio can be interpreted by the antenna as falling below the defined distance.

Sensor data generated by the environment sensor system 6 is evaluated by a computing unit 7. The computing unit 7 can be designed as a central on-board computer, control device of a vehicle subsystem, or similar.

To display the charging state 1 particularly clearly, the graphic 5 is displayed as a pictogram of a battery with five charging bars 8.1, 8.2, 8.3, 8.4 and 8.5. Depending on the charging state, an appropriate number of charging bars 8.1-8.5 is then displayed.

FIG. 2 shows the graphic 5 in detail at different times t1 t2 and t3. For example, an already fully charged part of the energy storage device 2 is displayed by permanently visualized charging bars 8.1, 8.2, 8.3. A portion that is currently being charged can be indicated by a flashing charging bar 8.4. This is indicated in FIG. 2 by the fading out of the charging bar 8.4 at the second time t2. An amount of energy still to be charged later can be symbolized by a charging bar 8.5 that is not shown. In general, the graphic 5 can be displayed in different colors, brightness, transparency, and/or contrast. For example, one of the charging bars 8.1-8.5 is representative of 20 per cent of the capacity of the energy storage device 2. Using the animated graphic 5 shown in FIG. 2, people looking at the graphic 5 can quickly and intuitively recognize that the energy storage device 2 of the vehicle 3 is currently being charged and will soon be fully charged.

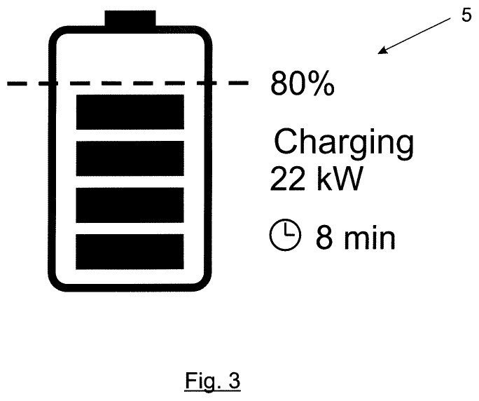

The graphic 5 can also be supplemented by other symbols, pictograms, text, numbers and/or special characters, as shown in FIG. 3.

FIG. 3 shows that the energy storage device 2 will be charged to a charging state of 80 per cent in eight minutes at 22 kW. This enables a further differentiated display of information.

The projection of the charging state into the surrounding area ends after a deactivation event has occurred, wherein one of the following actions is used as a deactivation event:
closing an open vehicle door;
locking the vehicle doors;
entering a manual operator control action;
activating the vehicle 3 ignition;
starting a drive engine of the vehicle 3; or
decoupling the vehicle 3 from a charging station.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-6. (canceled)

7. A method comprising:
detecting, by an environment sensor system of a vehicle, an approach, which is below a defined distance from the vehicle, of another vehicle, a person, or an identification feature;
projecting, by a lighting device of the vehicle and responsive to detecting the approach below the defined distance of the another vehicle, the person, or the identification feature, a charging state of an energy storage device of a vehicle, wherein the charging state is projected as a graphic onto a surface in a surrounding area of the vehicle by the lighting device; and
terminating the projecting of the charging state responsive to a deactivation event, which is
closing an open door of the vehicle,
locking doors of the vehicle,
entering a manual operator control action of the vehicle,
activating an ignition of the vehicle,
starting a drive engine of the vehicle, or
decoupling the vehicle from a charging station
wherein the lighting device includes at least one front headlight of the vehicle.

8. The method of claim 7,
wherein the graphic includes at least one symbol, pictogram, text, number, or special character, and
wherein
at least two image sections of the graphic have a color, brightness, contrast, or transparency differing from each other, or
at least one part of the graphic is animated.

9. The method of claim 7, wherein the at least one front headlight is a matrix headlight.

10. The method of claim 7, wherein the identification feature is integrated into a vehicle key, a transponder, or a mobile end-device.

11. A vehicle comprising:
a lighting device;
a computing unit; and
an environment sensor system,
wherein the environment sensor system is configured to detect an approach, which is below a defined distance from the vehicle, of another vehicle, a person, or an identification feature;
the lighting device is configured to project, responsive to detecting the approach below the defined distance of the another vehicle, the person, or the identification feature, a charging state of an energy storage device of a vehicle, wherein the charging state is projected as a graphic onto a surface in a surrounding area of the vehicle by the lighting device; and
the lighting device is configured to terminate the projecting of the charging state responsive to a deactivation event, which is
closing an open door of the vehicle,
locking doors of the vehicle,
entering a manual operator control action of the vehicle,
activating an ignition of the vehicle,
starting a drive engine of the vehicle, or
decoupling the vehicle from a charging station
wherein the lighting device includes at least one front headlight of the vehicle.

12. The vehicle of claim 11, wherein the at least one front headlight is a matrix headlight or comprises at least one matrix headlight.
